(19) United States
(12) Patent Application Publication
(10) Pub. No.: US 2016/0274883 A1
(43) Pub. Date: Sep. 22, 2016

(54) INFORMATION PROCESSING APPARATUS AND COMPUTER-READABLE RECORDING MEDIUM

(71) Applicant: Hirokazu IIDA, Kanagawa (JP)

(72) Inventor: Hirokazu IIDA, Kanagawa (JP)

(21) Appl. No.: 15/070,807

(22) Filed: Mar. 15, 2016

(30) Foreign Application Priority Data
Mar. 19, 2015 (JP) 2015-056098

(51) Int. Cl. G06F 9/445

(52) U.S. Cl. CPC G06F 8/61

(57) ABSTRACT

An information processing apparatus includes a first acquirer, a second acquirer, and an installer. The first acquirer acquires, from electronic device, identification information by which a driver program of the electronic device is identified. The second acquirer acquires the driver program identified by the identification information from a server apparatus. The installer installs the acquired driver program.

### CROSS-REFERENCE TO RELATED APPLICATION

The present application claims priority to and incorporates by reference the entire contents of Japanese Patent Application No. 2015-056098 filed in Japan on Mar. 19, 2015.

### BACKGROUND OF THE INVENTION

1. Field of the Invention

The present invention relates generally to an information processing apparatus and a computer-readable recording medium.

2. Description of the Related Art

Generally, printing to a printer from a PC (personal computer) requires that a printer driver supporting the printer to be used in the printing (hereinafter, “printing printer”) be installed on the PC. The printing printer can be designated at installation of the printer driver (by, e.g., manually entering the printing printer or performing a printer search through a subnetwork using a function provided by an OS (operating system)).

Installation of a printer driver is a difficult work for users unfamiliar with PCs and printers. For this reason, printer manufacturers generally provide, as means of assisting printer driver installation, means of installing a printer driver by performing a printer search through the same subnetwork as a target PC, downloading the latest version of printer driver supporting the printer's model, and performing printing-printer settings appropriately. For example, a technique in which a printer driver installer performs a printer search, downloads an appropriate printer driver from a server, and installs the printer driver is proposed in Japanese Laid-open Patent Application No. 2006-351035 (Patent Document 1).

However, with the conventional technique, a situation where a desired printer driver cannot be installed on a specific printer can disadvantageously occur. For example, it has been difficult to enable installation of different versions of printer driver on a printer A and a printer B of the same model.

Therefore, there is a need to provide an information processing apparatus and a computer-readable recording medium that can install a desired driver program on specific electronic device.

### SUMMARY OF THE INVENTION

It is an object of the present invention to at least partially solve the problems in the conventional technology.

According to an embodiment, there is provided an information processing apparatus that includes a first acquirer configured to acquire, from an electronic device, identification information for identifying a driver program of the electronic device; a second acquirer configured to acquire the driver program identified by the identification information from a server apparatus; and an installer configured to install the acquired driver program.

According to another embodiment, there is provided an information processing apparatus that includes a first acquirer configured to transmit a request for acquisition of a driver program of an electronic device to the electronic device and acquire the driver program returned by the electronic device in response to the acquisition request; a second acquirer configured to acquire the driver program from a server apparatus when the first acquirer fails to acquire the driver program; and an installer configured to install the acquired driver program.

According to still another embodiment, there is provided a non-transitory computer-readable recording medium with an executable program stored thereon and executed by a computer. The program instructs the computer to perform acquiring identification information for identifying a driver program from an electronic device; acquiring the driver program identified by the identification information from a server apparatus; and installing the acquired driver program.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example configuration of an information processing system according to a first embodiment;

FIG. 2 is a diagram illustrating an example hardware structure of a PC and a distribution server;

FIG. 3 is a diagram illustrating an example hardware structure of a printer;

FIG. 4 is a block diagram illustrating an example functional configuration of each apparatus of the information processing system of the first embodiment;

FIG. 5 is a sequence diagram illustrating an example of an installation process according to the first embodiment;

FIG. 6 is a diagram illustrating an example of an interface (selection screen);

FIG. 7 is a block diagram illustrating an example configuration of an information processing system according to a second embodiment;

FIG. 8 is a block diagram illustrating an example functional configuration of each apparatus of the information processing system of the second embodiment;

FIG. 9 is a diagram illustrating an example of a data structure of a device identifier table;

FIG. 10 is a diagram illustrating an example of a data structure of a model identifier table;

FIG. 11 is a sequence diagram illustrating an example of an installation process according to the second embodiment;

FIG. 12 is a block diagram illustrating an example configuration of an information processing system according to a modification;

FIG. 13 is a block diagram illustrating an example functional configuration of each apparatus of an information processing system of a third embodiment;

FIG. 14 is a sequence diagram illustrating an example of an installation process according to the third embodiment;

FIG. 15 is a block diagram illustrating an example configuration of an information processing system according to a fourth embodiment;

FIG. 16 is a block diagram illustrating an example functional configuration of each apparatus of the information processing system of the fourth embodiment; and

FIG. 17 is a sequence diagram illustrating an example of an installation process of the fourth embodiment.

### DETAILED DESCRIPTION OF THE PREFERRED EMBODIMENTS

Exemplary embodiments of the present invention are described in detail below with reference to the accompanying drawings. A printer and a printer driver are described below as an application example of electronic device and a driver program, respectively. Note that applicable electronic device is not limited thereto. The electronic device may alternatively be an MFP (multifunction peripheral), an LP (laser printer), an inkjet printer, a facsimile apparatus, a digital copier, a scanner apparatus, a projector, a camera, an automotive navigation system, a networked home appliance, and other electronic device. An MFP is an apparatus having at least two of a printer function, a copier function, a scanner function, and a facsimile function.

### First Embodiment

There can be a situation where different versions of printer driver are installed on printers that are of the same model but vary in location or the like. For example, there can be a case where printer drivers to be used vary depending on an IP address in the following manner:

for a printer at IP address (1.2.3.4): printer driver version 1.0;

for a printer at IP address (5.6.7.8): printer driver version 1.1;

for a printer at IP address (9.9.9.9): printer driver whose initial settings are customized; and

for a printer at IP address (1.1.1.1): custom-configured printer driver.

With a conventional method, when printers where printer drivers are to be installed are of the same model, the latest version of printer driver for the model is installed on every one of the printers. Hence, the conventional method is incapable of installing different printer drivers cannot be installed on printers of the same model as in the above-described case.

In the first embodiment, a printer holds information associating the printer with a printer driver. A printer driver installer on a PC downloads the printer driver associated with the printer by dynamically changing a printer-driver distribution server on the basis of the information acquired from the printer and installs the printer driver. Hence, it is possible to install a specific printer driver on a specific printer.

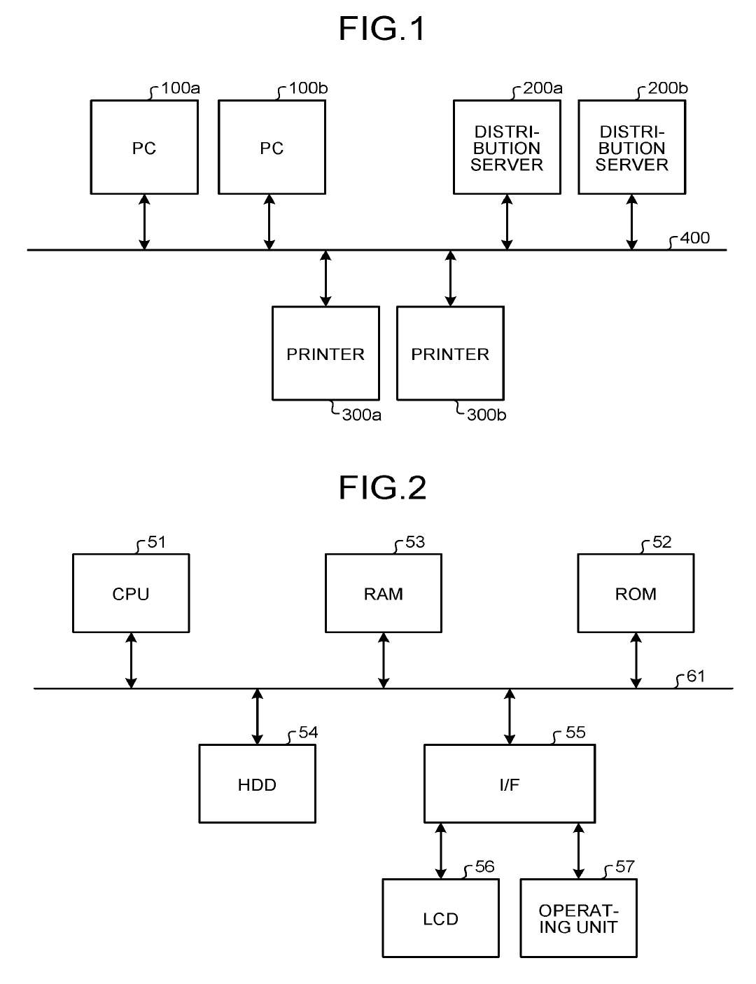

FIG. 1 is a block diagram illustrating an example configuration of an information processing system according to the first embodiment. As illustrated in FIG. 1, the information processing system of the first embodiment is formed by connecting PCs 100a and 100b, each of which is an example of “information processing apparatus”, distribution servers 200a and 200b, each of which is an example of “server apparatus”, and printers 300a and 300b via a network 400.

The number of the respective apparatuses is not limited to two but can be any number. Hereinafter, one of the PCs 100a and 100b may be simply referred to as “PC 100” when it is unnecessary to differentiate therebetween. Similarly, one of the distribution servers 200a and 200b and one of the printers 300a and 300b may be simply referred to as “distribution server 200” and “printer 300”, respectively.

The network 400 can be of any network form, such as a LAN (local area network) and the Internet.

FIG. 2 is a diagram illustrating an example hardware structure of the PC 100 and the distribution server 200. Although the following description is made by way of example of the PC 100, the distribution server 200 can have a similar structure.

As illustrated in FIG. 2, the PC 100 is formed by connecting a CPU (central processing unit) 51, a RAM (random access memory) 53, a ROM (read only memory) 52, an HDD (hard disk drive) 54, and an I/F (interface) 55 via a bus 61.

A liquid crystal display (LCD) 56 and an operating unit 57 are connected to the I/F 55.

The CPU 51 is computing means that controls operations of the entire PC 100. The RAM 53 is a volatile storage medium, to and from which information can be written and read at high speed, and used as a work area for information processing performed by the CPU 51. The ROM 52 is a read-only non-volatile storage medium where programs, such as firmware, are stored.

The HDD 54 is a non-volatile storage medium, to and from which information can be written and read. An OS, various control programs, application programs, and the like are to be stored in the HDD 54. The I/F 55 provides and controls connection between the bus 61, and various hardware, network, and the like.

The LCD 56 is a visual user interface that allows a user to check a condition of the PC 100. The operating unit 57 is an interface, such as a keyboard and a mouse, for use by a user in entering information to the PC 100.

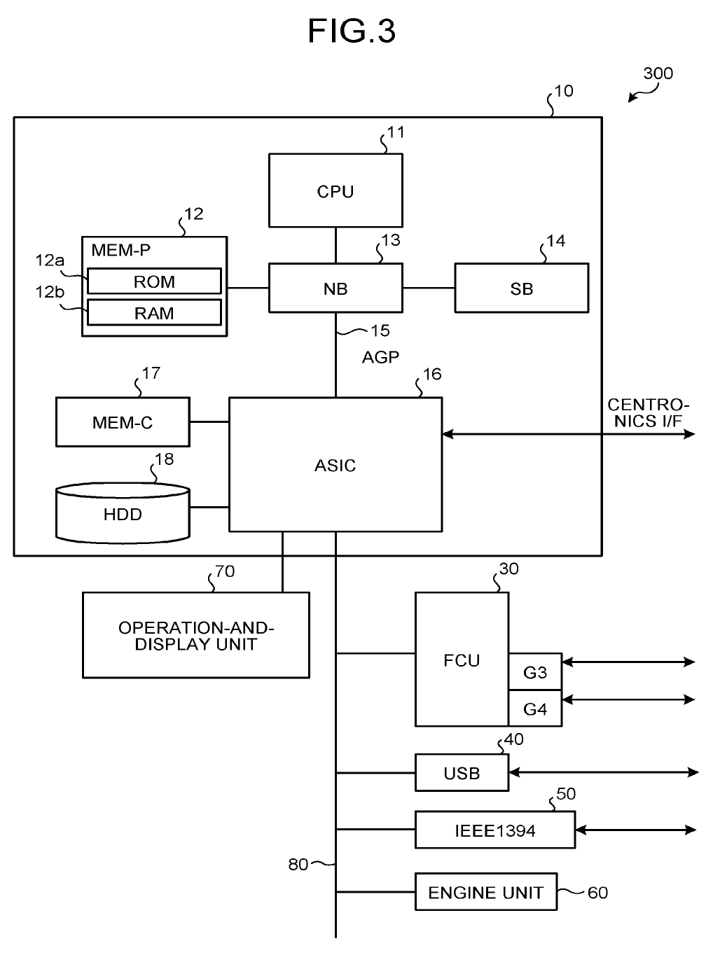

FIG. 3 is a diagram illustrating an example hardware structure of the printer 300. As illustrated in FIG. 3, the printer 300 is formed by connecting a controller 10 and an engine unit 60 via a PCI (peripheral component interface) bus 80.

The controller 10 controls the entire printer 300, image rendering, communication, inputs entered from an operation-and-display unit 70, and the like.

The engine unit 60 is, for example, a printer engine connectable to the PCI bus 80. Examples of the engine unit 60 include a monochrome plotter, a single-drum color plotter, a four-drum color plotter, a scanner unit, and a facsimile unit. The engine unit 60 includes, in addition to what may be referred to as an engine portion such as a plotter, a portion for image processing, such as error diffusion and gamma correction.

The controller 10 includes a CPU 11, a north bridge (NB) 13, a system memory (MEM-P) 12, a south bridge (SB) 14, a local memory (MEM-C) 17, an ASIC (application-specific integrated circuit) 16, and an HDD 18. The controller 10 is formed by connecting the north bridge (NB) 13 and the ASIC 16 via an AGP (accelerated graphics port) bus 15.

The CPU 11 controls the entire printer 300. The CPU 11 is connected to other device via a chip set including the NB 13, the MEM-P 12, and the SB 14, for example.

The NB 13 is a bridge for connecting the CPU 11 to the MEM-P 12, the SB 14, and the AGP bus 15. The NB 13 includes a PCI master, an AGP target, and a memory controller that controls reading and writing from and to the MEM-P 12 and the like.

The MEM-P 12 is a system memory for use as a memory for storing programs and data, a memory for loading programs and data thereinto, a memory for image rendering in a printer, and the like. The MEM-P 12 includes a ROM 12a and a RAM 12b.

The ROM 12a is a read-only memory for use as the memory for storing programs and data. The RAM 12b is writable and readable memory for use as the memory for loading programs and data thereinto, the memory for image rendering in a printer, and the like.

The SB 14 is a bridge for connecting the NB 13 to PCI devices and peripheral devices. The SB 14 is connected to the NB 13 via the PCI bus 80. A network interface (I/F) part and the like are also connected to the PCI bus 80.

The ASIC 16 is an IC (integrated circuit) for use in image processing and includes a hardware element for image processing. The ASIC 16 functions as a bridge connecting between each of the AGP bus 15, the PCI bus 80, the HDD 18, and the MEM-C 17. The ASIC 16 includes a PCI target and an AGP master, an arbiter (ARB) serving as the core for the ASIC 16, a memory controller controlling the MEM-C 17, a plurality of DMACs (direct memory access controllers) that performs image data rotation and the like by hardware logic, and a PCI unit that performs data transfer to and from the engine unit 60 via the PCI bus 80.

An FCU (facsimile control unit) 30, a USE (universal serial bus) 40, and an IEEE 1394 (the Institute of Electrical and Electronics Engineers 1394) interface 50 are connected to the ASIC 16 via the PCI bus 80.

The operation-and-display unit 70 is directly connected to the ASIC 16. The MEM-C 17 is a local memory for use as a copy-image buffer and a code buffer. The HDD 18 is storage for accumulating image data, programs, font data, and forms. The HDD 18 stores a license file(s) of an application program(s) (hereinafter, sometimes referred to as “application”) to be executed in the printer 300.

The AGP bus 15 is a bus interface for a graphics accelerator card introduced to accelerate graphics operations. The AGP bus 15 allows direct access to the MEM-P 12 at a high throughput, thereby enabling faster processing using the graphics accelerator card.

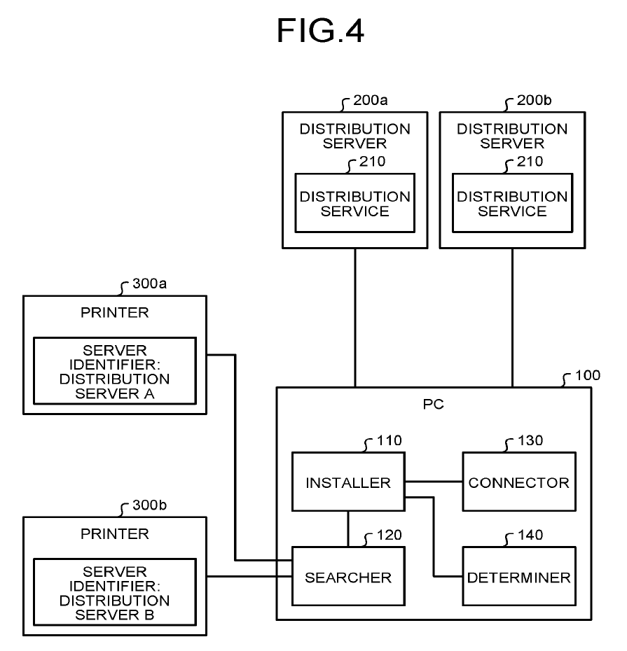

FIG. 4 is a block diagram illustrating an example functional configuration of each apparatus of the information processing system.

The printer 300 stores, in storage (e.g., the HDD 18), a server identifier of the distribution server 200 where a printer driver of the printer 300 is stored. The server identifier is an example of information (server identification information) by which the distribution server 200 is identified from among the distribution servers 200. For example, a URL (uniform resource locator) of the distribution server 200 can be used as the server identifier. The value of the server identifier may be configured to be user-definable.

FIG. 4 illustrates an example where “distribution server A” and “distribution server B” are stored as server identifiers of the printers 300a and 300b, respectively. The “distribution server A” and “distribution server B” are the server identifiers of the printer 300a and the printer 300b, respectively.

The PC 100 includes an installer 110, a searcher 120, a connector 130, and a determiner 140.

The installer 110 (an example of “installer” recited in the appended claims) has a function of installing a printer driver on the PC 100. The searcher 120 searches for the printer(s) 300 that is available. For example, the searcher 120 searches for the printer(s) 300 connected to the same subnetwork as the PC 100. Furthermore, the searcher 120 (an example of “first acquirer”) acquires a server identifier from each of the found printer(s) 300. The searcher 120 acquires the server identifier from each of the printer(s) 300 using, for example, an MIB (management information base). In the first embodiment, the server identifier is used as identification information for identifying a printer driver.

The connector 130 (an example of “second acquirer”) establishes connection to the distribution server 200 and acquires (i.e., downloads) a printer driver from the connected distribution server 200. For example, the connector 130 determines to which one of the distribution servers 200 connection is to be established on the basis of the server identifier acquired from the printer 300. The connector 130 submits a request for downloading a printer driver to the thus-determined distribution server 200.

Using URLs as the server identifiers is advantageous in that, even when a distribution server is newly added to belong to the distribution servers 200, processing for adapting to this addition can be done only in the printers 300. For a case where server identifiers other than URLs are used, the following configuration can be employed. For example, each of the printers 300 stores unique server identifiers, e.g., 123 and 456. The connector 130 refers to information (e.g., a table) where the server identifiers and the URLs are associated and determines a URL associated with the server identifier acquired from the printer 300 as the URL to which connection is to be established.

The determiner 140 determines a printer driver to be installed. The determiner 140 displays, for example, information (e.g., a printer list) indicating the one or more printers 300 found by the searcher 120 on a user interface, e.g., the LCD 56, thereby allowing a user to select a printer driver to be installed. The determiner 140 determines the printer driver selected by the user as the printer driver to be installed.

The distribution server 200 includes distribution service 210. The distribution service 210 (an example of “transmitter”) is service that distributes a printer driver in response to a request submitted from an external apparatus, such as the PC 100. For example, upon receiving a request from the PC 100, the distribution service 210 transmits a printer driver associated with a server identifier (e.g., a URL).

A single URL may be assigned to each of the distribution servers 200. Alternatively, a plurality of URLs may be assigned to the single distribution server 200. For the former case, the distribution server 200 may be configured to, upon receiving a request for a printer driver, distribute a printer driver stored in the distribution server 200. For the latter case, for example, the distribution server 200 may identify a printer driver associated with a URL designated by the PC 100 and distributes the identified printer driver to the PC 100.

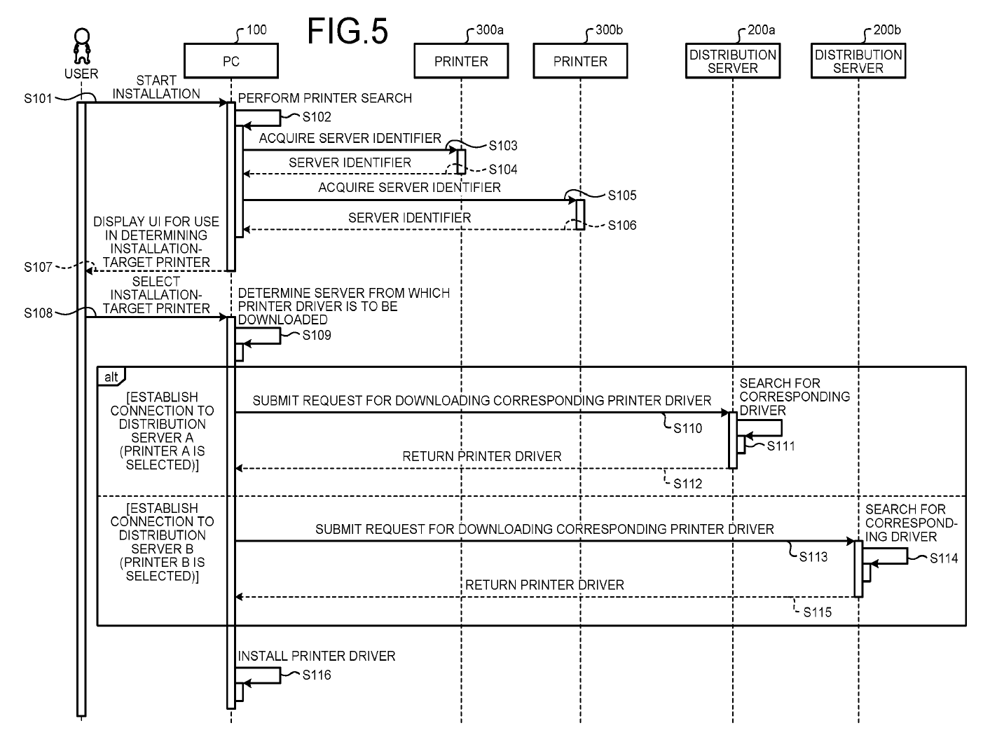

A printer-driver installation process performed by the PC 100 according to the first embodiment configured as described above is described below with reference to FIG. 5. FIG. 5 is a sequence diagram illustrating an example of the installation process according to the first embodiment.

Upon receiving, for example, an instruction to start installation from a user (Step S101), the searcher 120 of the PC 100 searches for the printer(s) 300 that is available (Step S102). For example, the searcher 120 searches for the printer(s) 300 on the same subnetwork as the PC 100. In this example, it is assumed that the printers 300a and 300b are found. The searcher 120 acquires a server identifier from each of the found printers 300 (Steps S103 to S106).

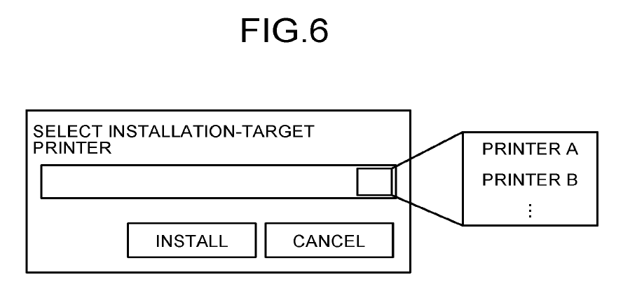

The determiner 140 displays a printer list indicating the printers 300 found by the searcher 120 and urges a user to select an installation-target printer (Step S107). FIG. 6 is a diagram illustrating an example of an interface (selection screen) displayed by the determiner 140. A user can select one of the printers 300 found by the searcher 120 as an installation-target printer through such an interface. When an instruction to discontinue installation is given from the user (e.g., when “CANCEL” button of FIG. 6 is clicked), the installation process ends.

When the installation-target printer 300 is selected by the user and an instruction to perform installation is given (e.g., when “INSTALL” button of FIG. 6 is clicked), the determiner 140 determines the printer driver selected by the user as an installation-target printer driver (Step S108).

The connector 130 determines the distribution server 200 from which the determined printer driver is to be downloaded (Step S109). For example, the connector 130 determines the distribution server 200 from which the printer driver is to be downloaded by referring to the server identifier acquired from the selected printer 300.

The connector 130 submits, to the thus-determined distribution server 200, a request for downloading the printer driver determined as installation target. For example, if the printer 300a (hereinafter, sometimes referred to as “printer A”) is selected and the server identifier “distribution server A” is acquired from the printer A, the connector 130 submits a request for downloading a printer driver to the distribution server 200a (Step S110). The distribution service 210 of the distribution server 200a searches for the corresponding printer driver (Step S111) and returns the found printer driver to the PC 100 (Step S112).

If the printer 300b (hereinafter, sometimes referred to as “printer B”) is selected and the server identifier “distribution server B” is acquired from the printer B, the connector 130 submits a request for downloading a printer driver to the distribution server 200b (Step S113). The distribution service 210 of the distribution server 200b searches for the corresponding printer driver (Step S114) and returns the found printer driver to the PC 100 (Step S115).

Thus, the connector 130 can identify the distribution server 200 identified by the server identifier or, put another way, identify the printer driver stored in the distribution server 200 identified by the server identifier.

The installer 110 of the PC 100 installs the printer driver downloaded from the distribution server 200 (Step S116).

As described above, in the first embodiment, a PC downloads a printer driver by dynamically changing a printer-driver distribution server on the basis of information acquired from a printer and installs the printer driver. Hence, it is possible to install a desired printer driver on a specific printer.

### Second Embodiment

In a second embodiment, device identification information (device identifier) by which a printer is uniquely identified is used as identification information for identifying a printer driver. In the second embodiment, the server identifier is used in determining from which one of a distribution server within an internal network (an example of “predetermined network”) and a distribution server outside the internal network the printer driver is to be acquired.

The second embodiment mainly differs from the first embodiment in the following respects:

the printer includes, in addition to the server identifier, the device identifier and a model identifier;

two distribution servers or, more specifically, a distribution server connected to the internal network and a distribution server (e.g., a distribution server in a manufacturer's site) connected to an external network, are used;

the distribution server has information (e.g., a table) associating the printer driver with the device identifier or the model identifier and transmits a printer driver associated with an identifier transmitted to the distribution server to a requesting PC; and

an installer on the PC acquires, in addition to the server identifier, the device identifier and the model identifier from the printer and transmits them to the distribution server together with a request for downloading the printer driver.

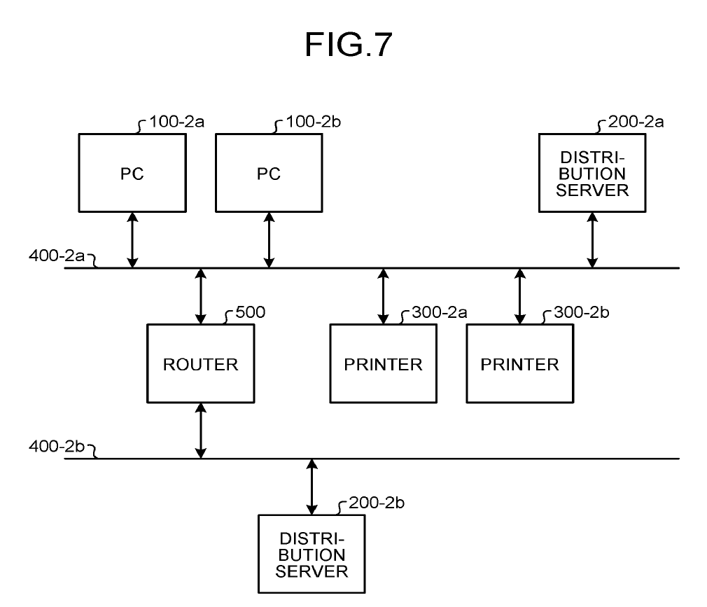

FIG. 7 is a block diagram illustrating an example configuration of an information processing system according to the second embodiment. As illustrated in FIG. 7, the information processing system of the second embodiment includes PCs 100-2a and 100-2b, distribution servers 200-2a and 200-2b, printers 300-2a and 300-2b, and a router 500.

The PCs 100-2a and 100-2b, the distribution server 200-2a, the printers 300-2a and 300-2b, and the router 500 are connected via an internal network 400-2a. The distribution server 200-2b is connected to the internal network 400-2a via an external network 400-2b and the router 500. Thus, the router 500 is a device that relays communication between the internal network 400-2a and the external network 400-2b.

The internal network 400-2a may be implemented in a LAN, for example. The external network 400-2b may be implemented in the Internet, for example. The distribution server 200-2b may be arranged in a manufacturer's site, for example.

The hardware structure diagram of each apparatus is similar to that of the first embodiment and repeated description is omitted.

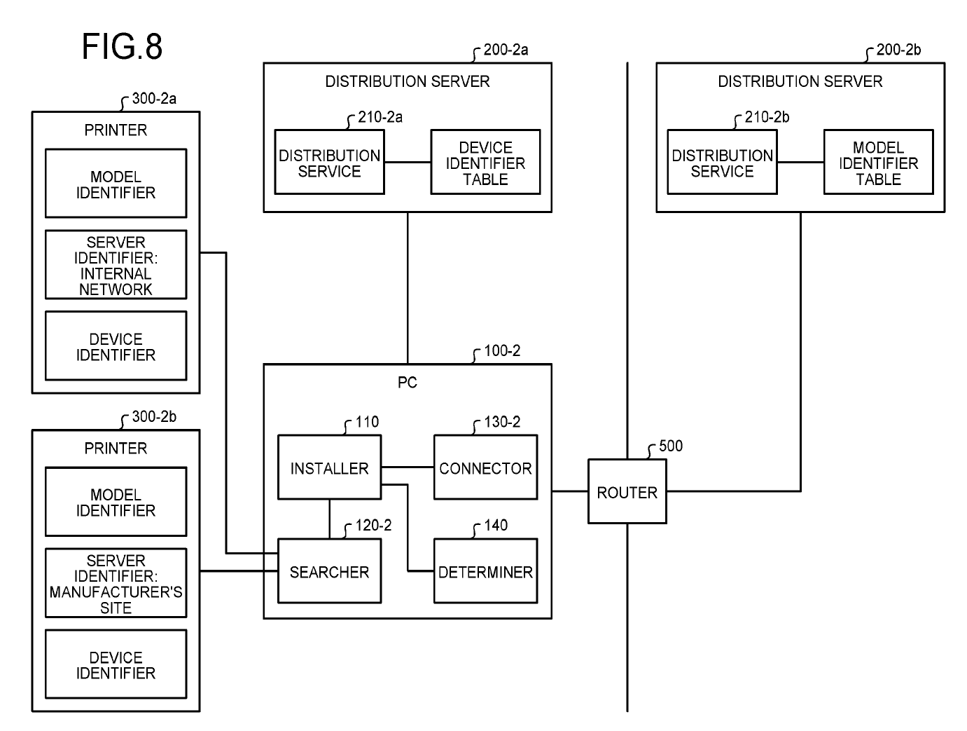

FIG. 8 is a block diagram illustrating an example functional configuration of the each apparatus of the information processing system. Elements similar to those of the first embodiment are denoted by like reference numerals and repeated description is omitted.

The printer 300-2 stores a server identifier, a model identifier, and a device identifier in storage (e.g., the HDD 18). The model identifier is an example of information (model identification information) by which the model of the printer 300-2 is uniquely identified. For example, a PnP (plug and play) name can be used as the model identifier. The server identifier is used to determine from which one of the distribution servers 200-2 a printer driver associated with the printer 300-2 is to be downloaded. The device identifier is information by which the printer is uniquely identified. For example, a MAC (media access control) address, an IP address, or the like can be used as the device identifier.

The PC 100-2 includes the installer 110, a searcher 120-2, a connector 130-2, and the determiner 140.

The searcher 120-2 differs from the searcher 120 of the first embodiment in acquiring not only a server identifier but also a model identifier and a device identifier from each of found printers.

The connector 130-2 differs from the connector 130 of the first embodiment in transmitting, to the distribution server 200-2 with which connection is established, information for use in determining a printer driver to be distributed. For example, the connector 130-2 transmits at least the device identifier to the distribution server 200-2a. Hence, the distribution server 200-2a can identify a printer driver to be distributed by the device identifier. The connector 130-2 transmits at least the model identifier to the distribution server 200-2b. Hence, the distribution server 200-2b can identify a printer driver to be distributed by the model identifier.

The connector 130-2 may determine which information is to be transmitted depending on the acquired server identifier. Alternatively, the connector 130-2 may, rather than performing such a determination process as described above, transmit information containing all information required by the distribution servers 200-2 to each of the distribution servers 200-2. In this case, each of the distribution servers 200-2 may preferably extract information necessary for the distribution server 200-2 and perform processing including identifying a printer driver.

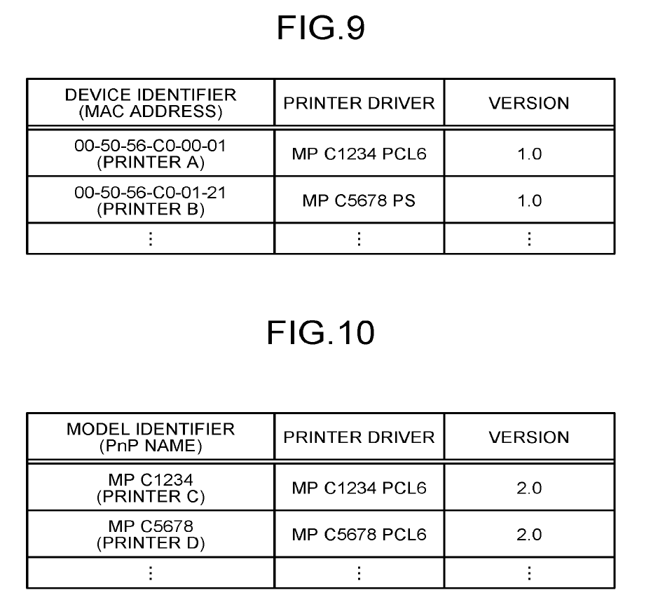

The distribution server 200-2a includes distribution service 210-2a. Furthermore, the distribution server 200-2a stores information (e.g., a device identifier table) associating device identifiers with printer drivers, in storage (e.g., an HDD). FIG. 9 is a diagram illustrating an example of a data structure of the device identifier table.

As illustrated in FIG. 9, the device identifier table stores device identifiers and printer driver names associated with each other. FIG. 9 illustrates an example where MAC addresses are used as the device identifiers. It is possible to arrange, as printer drivers, a specific version of printer driver, a custom-configured printer driver, and a printer driver whose initial settings are customized as illustrated in FIG. 9. Even if the printer A and the printer B are of the same model as illustrated in FIG. 9, it is possible to associate different printer drivers with the printers. The information, in which device identifiers are associated with printer drivers, is not necessarily in such a table form as illustrated in FIG. 9, and can be in any desired data form.

Referring back to FIG. 8, upon receiving the request from the PC 100, the distribution service 210-2a identifies a printer driver associated with the device identifier by referring to the device identifier table. The distribution service 210-2a transmits the identified printer driver to the requesting PC 100.

The distribution server 200-2b includes distribution service 210-2b. Furthermore, the distribution server 200-2b stores information (e.g., a model identifier table) associating model identifiers with printer drivers, in storage (e.g., an HDD). FIG. 10 is a diagram illustrating an example of a data structure of the model identifier table.

As illustrated in FIG. 10, the model identifier table stores model identifiers and printer driver names associated with each other. FIG. 10 illustrates an example where PnP names are used as the model identifiers. FIG. 10 illustrates an example where latest-version printer drivers of the respective models are registered. The information, in which model identifiers are associated with printer drivers, is not necessarily in such a table form as illustrated in FIG. 10, and can be in any desired data form.

Referring back to FIG. 8, upon receiving the request from the PC 100, the distribution service 210-2b identifies a printer driver associated with the model identifier by referring to the model identifier table. The distribution service 210-2b transmits the identified printer driver to the requesting PC 100.

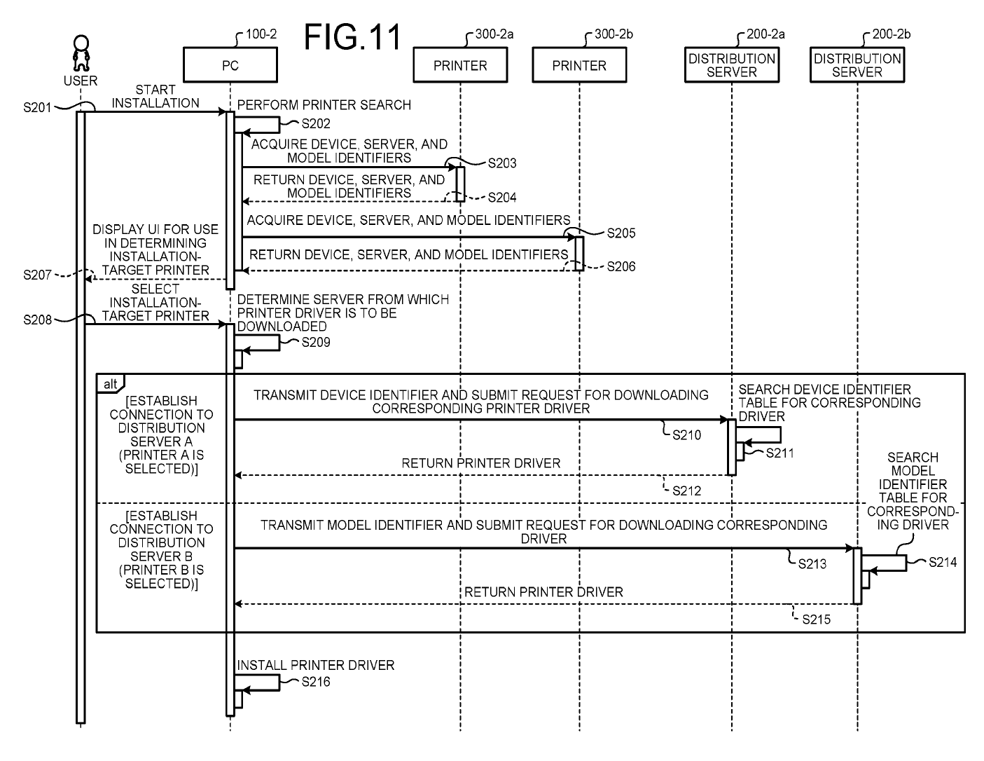

A printer-driver installation process performed by the PC 100-2 according to the second embodiment configured as described above is described below with reference to FIG. 11. FIG. 11 is a sequence diagram illustrating an example of the installation process according to the second embodiment.

Steps S201 and S202 are similar to Steps S101 and S102 of FIG. 5. The searcher 120-2 acquires a model identifier, a server identifier, and a device identifier from each of the found printers 300 (Steps S203 to S206). Steps S207 to S209 are similar to Steps S107 to S109 of FIG. 5.

The connector 130-2 submits a request for the printer driver determined as installation target to the distribution server 200-2 from which the printer driver is to be downloaded. For example, if the printer 300-2a (hereinafter, sometimes referred to as “printer A”) is selected, the connector 130-2 transmits the device identifier acquired from the printer A and submits a request for downloading a printer driver to the distribution server 200-2a (Step S210). The distribution service 210-2a of the distribution server 200-2a searches for a printer driver associated with the device identifier transmitted from the connector 130-2 (Step S211) and returns the found printer driver to the PC 100-2 (Step S212).

If the printer 300-2b (hereinafter, sometimes referred to as “printer B”) is selected, the connector 130-2 transmits the model identifier acquired from the printer B and submits a request for downloading a printer driver to the distribution server 200-2b (Step S213). The distribution service 210-2b of the distribution server 200-2b searches for a printer driver associated with the model identifier transmitted from the connector 130-2 (Step S214) and returns the found printer driver to the PC 100-2 (Step S215). Step S216 is similar to Step S116 of FIG. 5.

Thus, the connector 130-2 transmits the device identifier to the distribution server 200-2a when the connector 130-2 establishes connection to the distribution server 200-2a. This is because it is assumed that the number of the distribution servers 200-2 in the internal network 400-2a is limited to one (the distribution server 200-2a) and that a printer driver which is unique to each of the printers 300-2 is downloaded from the distribution server 200-2a. Accordingly, the distribution server 200-2a can identify a printer driver to be installed by the device identifier. A configuration in which, as in the first embodiment, the internal network 400-2a includes a plurality of the distribution servers 200-2 and the distribution server 200-2, from which a printer driver is to be downloaded, is switched depending on the printer 300-2, may alternatively be employed.

The connector 130-2 transmits the model identifier to the distribution server 200-2b when the connector 130-2 establishes connection to the distribution server 200-2b. This is because it is assumed that a specific version (e.g., the latest version), which is determined on a per-model basis, of printer driver is to be downloaded from the distribution server 200-2b arranged in, for example, a manufacturer's site. To a situation where the manufacturer's site can provide a mechanism that allows customizing printer drivers to be downloaded on a per-client-environment basis and on a per-device basis, a configuration where the distribution server 200-2b has a table (device identifier table) where device identifiers are associated with printer drivers may be applied.

A configuration where, as in the first embodiment, one of the distribution server 200-2a and the distribution server 200-2b, from which a printer driver is to be downloaded, is identified by a server identifier may be employed. This configuration eliminates the need of using the device identifiers.

### Modifications

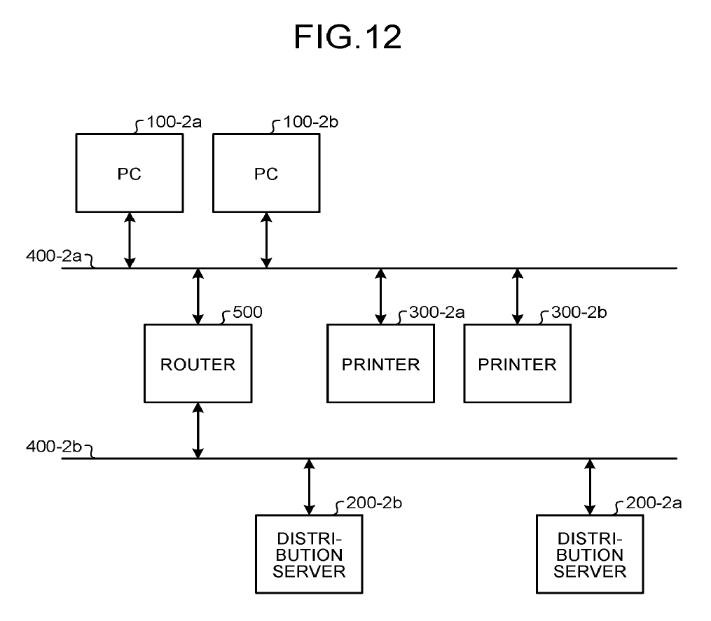

The distribution server 200-2a may also be arranged on the external network 400-2b. FIG. 12 is a block diagram illustrating an example configuration of an information processing system according to a modification configured as described above. As illustrated in FIG. 12, in the information processing system of the present modification, the distribution server 200-2a is connected to the external network 400-2b. An installation process of the modification is similar to that of the second embodiment and repeated description is omitted.

A modification where the distribution server 200-2a and the distribution server 200-2b are physically integrated into a single apparatus, and the distribution service 210-2a and the distribution service 210-2b that are respectively associated with the distribution servers 200-2a and 200-2b are assigned with different URLs is also applicable.

### Third Embodiment

In a third embodiment, information (search flag) indicating whether or not to acquire a printer driver from a distribution server in a predetermined network (e.g., the internal network) is used as identification information by which a printer driver is identified. In the third embodiment, neither the server identifiers nor the device identifiers are used.

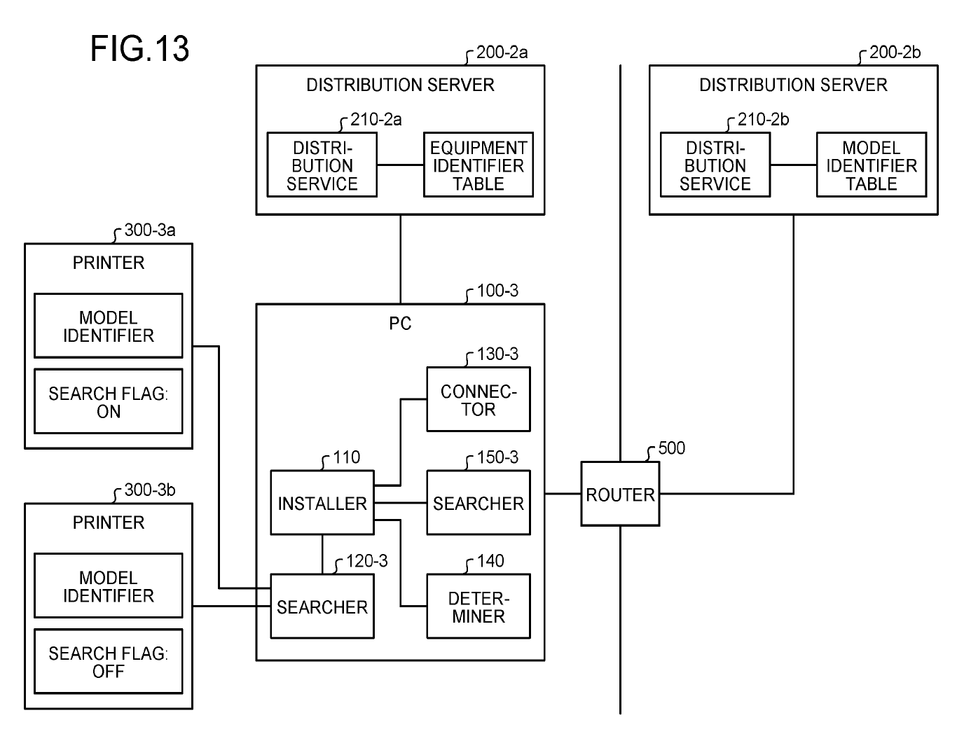

The overall configuration of an information processing system according to the third embodiment and the hardware structure diagram of each apparatus are similar to those of the second embodiment, and repeated description is omitted. FIG. 13 is a block diagram illustrating an example functional configuration of the each apparatus of the information processing system of the third embodiment. Elements similar to those of the above-described embodiment are denoted by like reference numerals and repeated description is omitted.

Each of printers 300-3 stores a model identifier and a search flag in storage (e.g., the HDD 18). The search flag is information designating whether or not a searcher 150-3 should search for a corresponding printer driver in the distribution server 200-2a on the same subnetwork (e.g., in the internal network 400-2a) as the PC 100-3.

For example, a search flag set to “On” indicates that it is designated to perform a search for a printer driver in the distribution server 200-2a. A search flag set to “Off” indicates that it is designated not to perform the search for a printer driver in the distribution server 200-2a. If the search flag is set to “On”, a printer driver found in the distribution server 200-2a will be installed. If no printer driver is found or if the search flag is set to “Off”, a corresponding printer driver is downloaded from outside the internal network 400-2a or, more specifically, from the distribution server 200-2b on the external network 400-2b.

A PC 100-3 includes the installer 110, a searcher 120-3, a connector 130-3, the determiner 140, and the searcher 150-3.

The searcher 120-3 differs from the searcher 120-2 of the second embodiment in acquiring a model identifier and a search flag from each of the found printers 300-3.

The connector 130-3 determines whether or not to perform a search for the distribution server 200-2a in the internal network 400-2a on the basis of the search flag acquired from the printer 300-3. If the search flag is set to “On”, the connector 130-3 submits a request for performing a search in the internal network 400-2a to the searcher 150-3. If the search flag is set to “Off”, the connector 130-3 establishes connection to the distribution server 200-2b. For example, the connector 130-3 may establish connection to the distribution server 200-2b using a preset URL of the distribution server 200-2b.

Upon receiving the request from the connector 130-3, the searcher 150-3 searches for the distribution server 200-2a by submitting, to every device in the same subnetwork as the PC 100-3, an inquiry as to whether or not the device is a distribution server. A configuration which does not use the search flag but in which the connector 130-3 performs a search for a distribution server(s) in the internal network 400-2a first and, if not found, the connector 130-3 establishes connection to the distribution server 200-2b may alternatively be employed.

The distribution servers 200-2a and 200-2b are similar in configuration to the distribution server 200-2b of the second embodiment. Specifically, in the third embodiment, the distribution server 200-2a in the internal network 400-2a also stores the model identifier table and identifies a printer driver associated with a model identifier.

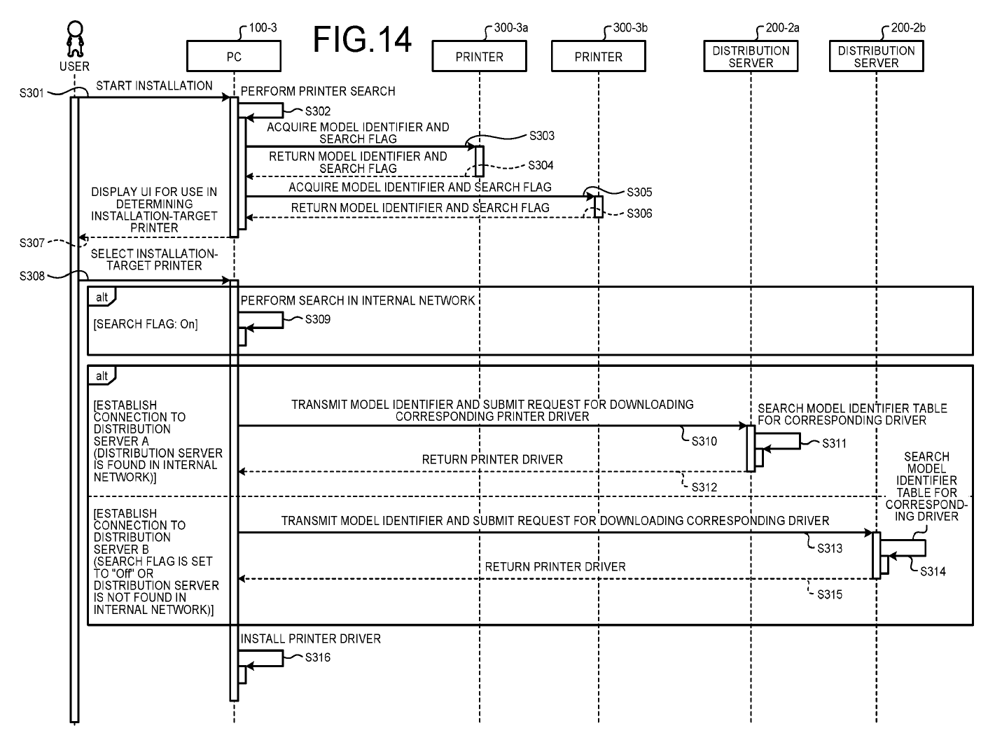

A printer-driver installation process performed by the PC 100-3 according to the third embodiment configured as described above is described below with reference to FIG. 14. FIG. 14 is a sequence diagram illustrating an example of the installation process according to the third embodiment.

Steps S301 and S302 are similar to Steps S201 and S202 of FIG. 11. The searcher 120-3 acquires a model identifier and a search flag from each of the found printers 300-3 (Steps S303 to S306). Steps S307 and S308 are similar to Steps S207 and S208 of FIG. 11.

The connector 130-3 determines whether or not to perform a search for the distribution server 200-2a in the internal network 400-2a on the basis of the search flag acquired from the selected printer 300-3. If the search flag is set to “On”, the searcher 150-3 searches for the distribution server 200-2a (Step S309).

The connector 130-3 submits a request for downloading the printer driver determined as installation target to the distribution server 200-2 from which the printer driver is to be downloaded. For example, if the distribution server 200-2a is found, the connector 130-3 transmits the model identifier acquired from the printer 300-3 and submits a request for downloading a printer driver to the distribution server 200-2a (Step S310). The distribution service 210-2b of the distribution server 200-2a searches for a printer driver associated with the model identifier transmitted from the connector 130-3 (Step S311) and returns the found printer driver to the PC 100-3 (Step S312).

If the distribution server 200-2a is not found or if the search flag is set to “Off”, the connector 130-3 transmits the model identifier acquired from the printer 300-3 and submits a request for downloading a printer driver to the distribution server 200-2b (Step S313). The distribution service 210-2b of the distribution server 200-2b searches for a printer driver associated with the model identifier transmitted from the connector 130-3 (Step S314) and returns the found printer driver to the PC 100-3 (Step S315). Step S316 is similar to Step S216 of FIG. 11.

### Fourth Embodiment

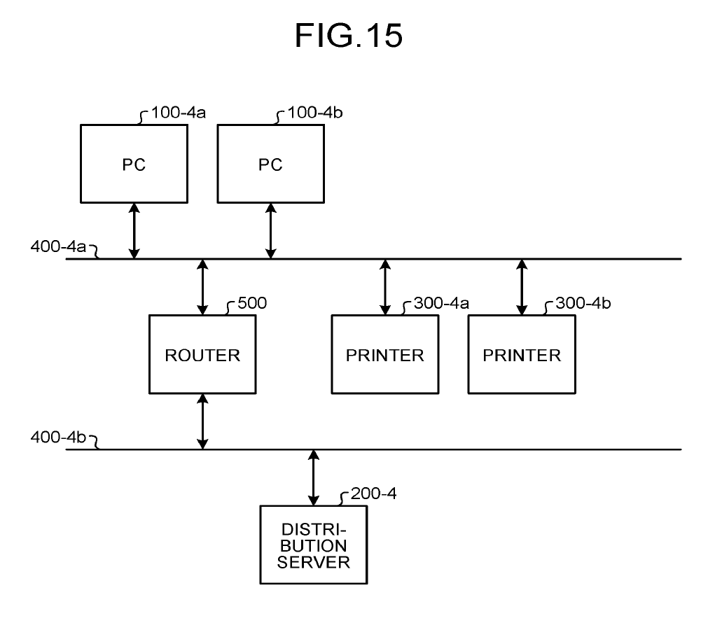

In a fourth embodiment, an example where the printer has a function (distribution service) of distributing its own printer driver is described. FIG. 15 is a block diagram illustrating an example configuration of an information processing system according to the fourth embodiment. As illustrated in FIG. 15, the information processing system of the fourth embodiment includes PCs 100-4a and 100-4b, a distribution server 200-4, printers 300-4a and 300-4b, and the router 500.

The PCs 100-4a and 100-4b, the printers 300-4a and 300-4b, and the router 500 are connected via an internal network 400-4a. The distribution server 200-4 is connected to the internal network 400-4a via an external network 400-4b and the router 500.

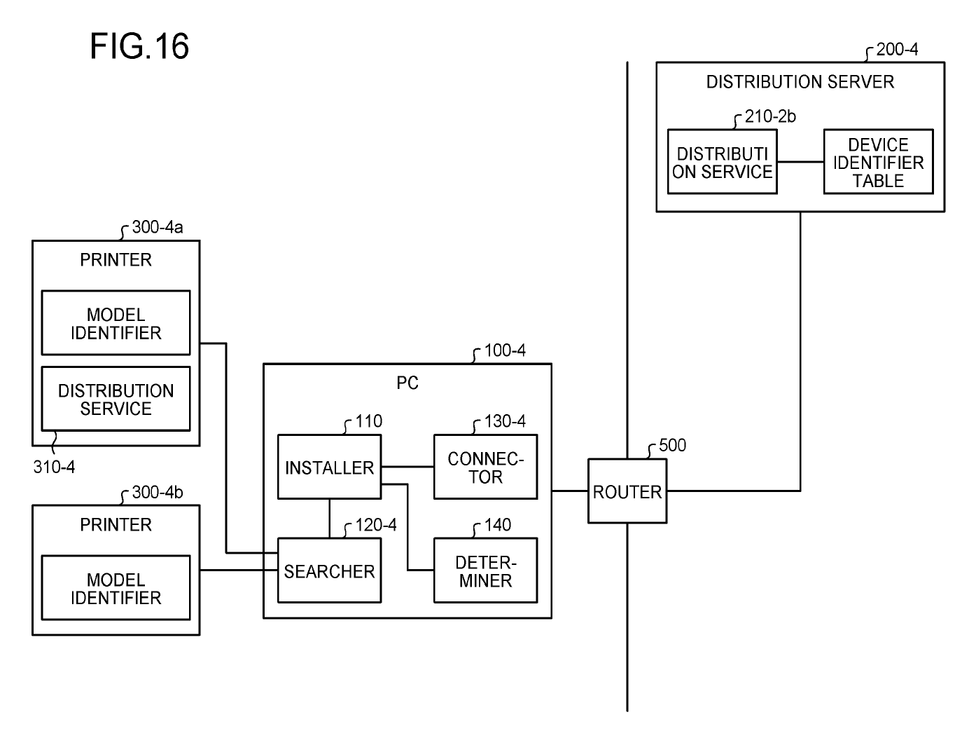

The hardware structure diagram of each apparatus is similar to that of the above-described embodiment and repeated description is omitted. FIG. 16 is a block diagram illustrating an example functional configuration of the each apparatus of the information processing system. Elements similar to those of the above-described embodiment are denoted by like reference numerals and repeated description is omitted.

With reference to FIG. 16, an example where the printer 300-4a has distribution service (distribution service 310-4) is described. The printer 300-4b may also include the distribution service 310-4. The printer 300-4 stores a model identifier in storage (e.g., the HDD 18).

Upon receiving the request from the PC 100-4, the distribution service 310-4 transmits a printer driver which is unique to each of the printers 300-4 to the requesting PC 100-4.

The PC 100-4 includes the installer 110, a searcher 120-4, a connector 130-4, and the determiner 140.

The searcher 120-4 searches for the printers 300-4 connected to the same subnetwork as the PC 100-4 and acquires model identifiers from the found printers 300-4 using an MIB, for example.

The connector 130-4 (an example of “first acquirer”) submits a request for a printer driver to the distribution service 310-4 of the printer 300-4 determined as installation target and downloads the printer driver. When the request is not carried out by the printer 300-4, the connector 130-4 (an example of “second acquirer”) establishes connection to the distribution server 200-4 and downloads the printer driver from the distribution server 200-4.

The distribution server 200-4 is similar in configuration to the distribution server 200-2b of the above-described embodiment.

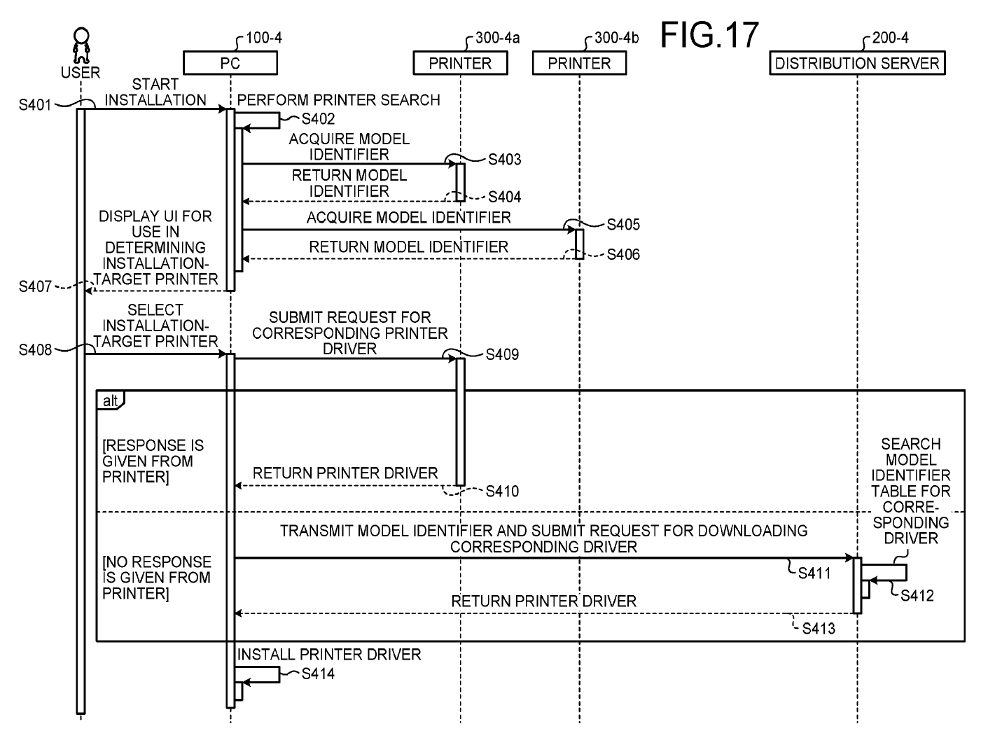

A printer-driver installation process performed by the PC 100-4 according to the fourth embodiment configured as described above is described below with reference to FIG. 17. FIG. 17 is a sequence diagram illustrating an example of the installation process according to the fourth embodiment.

Steps S401 and S402 are similar to Steps S301 and S302 of FIG. 14. The searcher 120-4 acquires a model identifier from each of the found printers 300-4 (Steps S403 to S406). Steps S407 and S408 are similar to Steps S307 and S308 of FIG. 14.

The connector 130-4 submits a request for a printer driver to the selected printer 300-4 (Step S409). If the printer 300-4 has the distribution service 310-4, the distribution service 310-4 can respond to the request. If a response to the request is given, the connector 130-4 acquires the printer driver from the distribution service 310-4 of the printer 300-4 (Step S410).

If no response to the request is given, the connector 130-4 transmits the model identifier acquired from the printer 300-4 and submits a request for downloading a printer driver to the distribution server 200-4 (Step S411). The distribution service 210-2b of the distribution server 200-4 searches for a printer driver associated with the model identifier transmitted from the connector 130-4 (Step S412) and returns the found printer driver to the PC 100-4 (Step S413). Step S414 is similar to Step S316 of FIG. 14.

The program to be executed by the respective apparatuses of each of the embodiments may be provided as being stored in the ROM 52 or the like in advance.

The program to be executed by an apparatus of each of the embodiments may be configured to be provided as a computer-readable recording medium, such as a CD-ROM, an FD (flexible disk), a CD-R, or a DVD (digital versatile disk), as an installable file or an executable file.

The program to be executed by an apparatus of each of the embodiments may be configured to be stored in a computer connected to a network, such as the Internet, and provided by being downloaded via the network. The program to be executed by an apparatus of each of the embodiments may be configured to be provided or distributed via a network, such as the Internet.

The program to be executed by an apparatus of each of the embodiments are configured as modules including the above-described components (e.g., the installer 110, the searcher 120, the connector 130, and the determiner 140). From a perspective of actual hardware, the CPU 51 (processor) reads out the program from the ROM 52 and executes them to load the components into a main memory device, thereby generating the components on the main memory device.

The above-described components may not necessarily be implemented by causing a processor, e.g., the CPU 51, to execute program or, in short, by software. Alternatively, the components may be implemented by hardware, such as an IC (integrated circuit), or by a combination of software and hardware.

According to an aspect of the present invention, it is advantageously possible to install a desired driver program on specific electronic device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a first acquirer configured to acquire, from an electronic device, identification information for identifying a driver program of the electronic device;
a second acquirer configured to acquire the driver program identified by the identification information from a server apparatus; and
an installer configured to install the acquired driver program.

2. The information processing apparatus according to claim 1, wherein
the identification information is server identification information for identifying a server apparatus or one of a plurality of server apparatuses, each server apparatus storing a driver program, and
the second acquirer acquires, from the server apparatus identified by the server identification information, the driver program stored in the server apparatus.

3. The information processing apparatus according to claim 2, wherein
the plurality of server apparatuses include a first server apparatus and a second server apparatus,
the first acquirer further acquires, from the electronic device, device identification information for identifying the electronic device and model identification information for identifying a model of the electronic device, and
when the first server apparatus is identified by the server identification information, the second acquirer transmits at least the device identification information to the first server apparatus, and acquires a driver program returned by the first server apparatus on the basis of the device identification information transmitted from the second acquirer, and
when the second server apparatus is identified by the server identification information, the second acquirer transmits at least the model identification information to the second server apparatus, and acquires a driver program returned by the second server apparatus on the basis of the model identification information transmitted from the second acquirer.

4. The information processing apparatus according to claim 1, wherein
the plurality of server apparatuses include a first server apparatus in a predetermined network and a second server apparatus outside the network,
the identification information is information indicating whether to acquire the driver program from the first server apparatus,
when the identification information indicates that the driver program is to be acquired from the first server apparatus, the second acquirer acquires a driver program from the first server apparatus, and
when the identification information does not indicate that the driver program is to be acquired from the first server apparatus, the second acquirer acquires a driver program from the second server apparatus.

5. The information processing apparatus according to claim 1, wherein
the first acquirer acquires, from the electronic device, device identification information for identifying the electronic device as the identification information, and
the second acquirer transmits at least the device identification information to the server apparatus, and acquires the driver program returned by the server apparatus on the basis of the device identification information transmitted from the second acquirer.

6. An information processing apparatus comprising:
a first acquirer configured to transmit a request for acquisition of a driver program of an electronic device to the electronic device and acquire the driver program returned by the electronic device in response to the acquisition request;
a second acquirer configured to acquire the driver program from a server apparatus when the first acquirer fails to acquire the driver program; and
an installer configured to install the acquired driver program.

7. A non-transitory computer-readable recording medium with an executable program stored thereon and executed by a computer, wherein the program instructs the computer to perform:
acquiring identification information for identifying a driver program from an electronic device;
acquiring the driver program identified by the identification information from a server apparatus; and
installing the acquired driver program.

8. The computer-readable recording medium according to claim 7, wherein
the identification information is server identification information for identifying a server apparatus or one of a plurality of server apparatuses, each server apparatus storing a driver program, and
at acquiring the driver program, the driver program stored in the server apparatus is acquired from the server apparatus identified by the server identification information.

9. The computer-readable recording medium according to claim 8, wherein
the plurality of server apparatuses include a first server apparatus and a second server apparatus,
at acquiring the identification information, device identification information for identifying the electronic device and model identification information for identifying a model of the electronic device are acquired from the electronic device, and
when the first server apparatus is identified by the server identification information, at acquiring the driver program, at least the device identification information is transmitted to the first server apparatus, and a driver program returned by the first server apparatus on the basis of the transmitted device identification information is acquired, and
when the second server apparatus is identified by the server identification information, at acquiring the driver program, at least the model identification information is transmitted to the second server apparatus, and a driver program returned by the second server apparatus on the basis of the transmitted model identification information is acquired.

10. The computer-readable recording medium according to claim 7, wherein
the plurality of server apparatuses include a first server apparatus in a predetermined network and a second server apparatus outside the network,
the identification information is information indicating whether to acquire the driver program from the first server apparatus,
when the identification information indicates that the driver program is to be acquired from the first server apparatus, at acquiring the driver program, a driver program is acquired from the first server apparatus, and
when the identification information does not indicate that the driver program is to be acquired from the first server apparatus, at acquiring the driver program, a driver program is acquired from the second server apparatus.

11. The computer-readable recording medium according to claim 7, wherein
at acquiring the identification information, device identification information for identifying the electronic device is acquired as the identification information from the electronic device, and
at acquiring the driver program, at least the device identification information is transmitted to the server apparatus, and the driver program returned by the server apparatus on the basis of the transmitted device identification information is acquired.
